(19) United States
(12) Patent Application Publication
(10) Pub. No.: US 2026/0039076 A1
(43) Pub. Date: Feb. 5, 2026

(54) LARGE CURRENT CABLE CONNECTOR

(71) Applicant: JESS-LINK PRODUCTS CO., LTD., New Taipei City (TW)

(72) Inventors: Yung-Chih FAN, New Taipei City (TW); Chun-Chia CHEN, New Taipei City (TW); Sheng-Ho YANG, New Taipei City (TW)

(21) Appl. No.: 18/891,443

(22) Filed: Sep. 20, 2024

(30) Foreign Application Priority Data
Jul. 31, 2024 (TW) 113128611

(51) Int. Cl. H01R 25/16; H01R 4/60; H01R 12/72

(52) U.S. Cl. CPC H01R 25/167; H01R 12/721; H01R 4/60

(57) ABSTRACT

A large current cable connector having an insulating body, a positive conductor, and a negative conductor is provided. The positive conductor includes a first buried section and a first exposed section and has a plurality of positive wiring-seats. The negative conductor includes a second buried section and a second exposed section and has a plurality of negative wiring-seats. The first buried section and the second buried section are arranged in the insulating body. The first exposed section and the second exposed section are exposed outside the insulating body. Some of the positive wiring-seats are located on a side of the positive conductor, others are located on another side of the positive conductor. Some of the negative wiring-seats are located on a side of the negative conductor, others are located on another side of the negative conductor. The large current cable connector is therefore conveniently manufacturing and assembling cables quickly.

### BACKGROUND

### Technical Field

The present disclosure relates to connector field, particularly to a large current cable connector with simple structure and easy assembly.

### Description of Related Art

With the development of industrial technology, various types of electronic equipment have been an indispensable part of the residence, school, company, factory and other occasions. In order to achieve quick connection and quick disassembly between different electronic components and accomplish the purpose of power transmission or signal transmission, various types of connectors are widely used in electronic equipment. The current connector, as one of the main connectors, is used for power supply or power input, and generally connects positive cable and negative cable electrically with overlap terminals to transmit power. The positive cable and negative cable of existing current connector are welded on different adapter boards, then be respectively connected to the main metal conductors through welding, fastening, or riveting to form an electrical connection with the overlap terminals.

However, this method is not only complicated in overall structure, not easy to manufacture parts, and cumbersome in assembly, but also causes high current impedance at the connection between the adapter plates and the metal conductors such that the current characteristics are affected. In addition, when a current connector needs to be assembled with a plurality of positive cables and a plurality of negative cables at the same time to increase the current, the assembler needs to spend more time for assembly, and the connection between the adapter plates and the metal conductors is prone to overheating due to the high current impedance. Furthermore, the positive cable and negative cable of existing current connector are extending away from the overlap terminals such that the occupied space is restricted, and the wiring way of bundling the positive cable and negative cable together causes heat accumulation in the welding joint easily and it hinders heat dissipation.

In view of the above, the inventor seeks to overcome the aforementioned drawbacks associated with the current technology and aims to provide an effective solution through extensive researches along with utilization of academic principles and knowledge.

### SUMMARY

The primary objective of the present disclosure is to make the large current cable connector easy to manufacture, to make the cables easy to assemble, and to reduce the occupied space of the cables to improve the heat dissipation efficiency of the cable connections.

To accomplish the aforementioned objective, the present disclosure provides a large current cable connector for connecting a plurality of positive cables and a plurality of negative cables. The large current cable connector includes an insulating body, a positive conductor, and a negative conductor. The positive conductor includes a first buried section and a first exposed section connecting to each other. The first buried section is arranged in the insulating body. The first exposed section extends along a third direction to expose outside the insulating body. The positive conductor has a plurality of positive wiring-seats for connecting the positive cables. Part of the positive wiring-seats are located on a side of the positive conductor such that the corresponding positive cables extend along a first direction. Another part of the positive wiring-seats is located on another side of the positive conductor such that the corresponding positive cables extend along a second direction. The first direction and the second direction are respectively perpendicular to the third direction. The negative conductor includes a second buried section and a second exposed section connecting to each other. The second buried section is arranged in the insulating body The second exposed section extends along the third direction to expose outside the insulating body. The negative conductor has a plurality of negative wiring-seats for connecting the negative cables. Part of the negative wiring-seats are located on a side of the negative conductor such that the corresponding negative cables extend along the first direction. Another part of the negative wiring-seats is located on another side of the negative conductor such that the corresponding negative cables extend along the second direction.

Another aspect of the present disclosure provides that a number of the positive wiring-seats is equal to a number of the negative wiring-seats.

Another aspect of the present disclosure provides that one of the positive wiring-seats is located on an end of the first exposed section such that the corresponding positive cables extend along the third direction, one of the negative wiring-seats is located on an end of the second exposed section such that the corresponding negative cables extend along the third direction.

Another aspect of the present disclosure provides that the second exposed section is staggered and arranged parallel to the first exposed section.

Another aspect of the present disclosure provides that the first direction and the second direction are opposite directions and parallel to each other.

Another aspect of the present disclosure provides that the positive wiring-seats are sequentially staggered on two different sides of the positive conductor, the negative wiring-seats are sequentially staggered on two different sides of the negative conductor.

Another aspect of the present disclosure provides that each of the positive wiring-seats and each of the negative wiring-seats are arc, semicircle, C-shaped, V-shaped or C-shaped.

Another aspect of the present disclosure provides that the first exposed section has a pair of first bending portions, the first bending portions respectively extend from the first exposed section toward the first direction and the second direction, part of the positive wiring-seats are located on the first bending portions extended toward the first direction such that the corresponding positive cables extend along the first direction, another part of the positive wiring-seats located on the first bending portions extended toward the second direction such that the corresponding positive cables extend along the second direction.

Another aspect of the present disclosure provides that the second exposed section has a pair of second bending portions, the second bending portions respectively extend from the second exposed section toward the first direction and the second direction, part of the negative wiring-seats are located on the second bending portions extended toward the first direction such that the corresponding positive cables extend along the first direction, another part of the negative wiring-seats located on the second bending portions extended toward the second direction such that the corresponding positive cables extend along the second direction.

Another aspect of the present disclosure provides that the insulating body has a pair of plug-clamping plates opposite to each other, the first buried section includes a first connecting portion and a plurality of positive terminals, the first connecting portion is connected between the first exposed section and the positive terminals, each of the positive terminals is corresponding to one of the plug-clamping plates, the second buried section includes a second connecting portion and a plurality of negative terminals, the second connecting portion is connected between the second exposed section and the negative terminals, the negative terminals are configured to the other plug-clamping plate.

In the large current cable connector of the present disclosure, a plurality of positive wiring-seats is arranged on the first exposed section of the positive conductor, a plurality of negative wiring-seats is arranged on the second exposed section of the negative conductor, the positive wiring-seats are respectively arranged on two different sides of the first exposed section, and the negative wiring-seats are respectively arranged on two different sides of the second exposed section. Therefore, the large current cable connector is easy to manufacture, renders quick assembling of the positive cables on the positive wiring-seats and quick assembling of the negative cables on the negative wiring-seats by user, and may reduce the occupied space of the positive cables and the negative cables to improve the heat dissipation efficiency of the connections of the positive cables and the negative cables.

### BRIEF DESCRIPTION OF THE DRAWINGS

FIG. 1 is a perspective appearance view in first embodiment of the present disclosure;

FIG. 2 is a perspective appearance view in first embodiment of the present disclosure after assembling the cables;

FIG. 3 is a side view in first embodiment of the present disclosure after assembling the cables;

FIG. 4 is a cross-sectional side view of the positive conductor and the negative conductor in first embodiment of the present disclosure;

FIG. 5 is a schematic diagram in first embodiment of the present disclosure in use;

FIG. 6 is a perspective appearance view in second embodiment of the present disclosure;

FIG. 7 is a perspective appearance view in second embodiment of the present disclosure after assembling the cables;

FIG. 8 is a side view in second embodiment of the present disclosure after assembling the cables;

FIG. 9 is a cross-sectional side view of the positive conductor and the negative conductor in second embodiment of the present disclosure.

### DETAILED DESCRIPTION

It is to be understood that the terms for indicating positions and the location relation, for example “front”, “rear”, “left”, “right”, “front end”, “rear end”, “distal end”, “longitudinal direction”, “lateral direction”, “vertical direction”, “top” and “bottom”, are based on the positions and the location relation disclosed in the drawings, and only used for disclosing the present disclosure and not used for indicating or implying the specified location of the device or the components or the specified structure and operation in certain location, thus the present disclosure is not intended to be limiting.

For example, the terms of “first”, “second”, “third”, “forth” and “fifth” are used for illustrating each unit, component, area, layer and/or part. The component, the unit, the area, the layer and/or the part are not limited by the terms. These terms are only used for separating the element, the assembly, the area, the layer, or the part. Unless being clearly indicated according to the whole specification, the terms for example “the first”, “the second”, “the third”, “the fourth” and “the fifth” are not used for implying the order or sequence.

As used herein and not otherwise defined, the terms “substantially” and “approximately” are used to describe and describe small changes. When used in connection with an event or situation, the terms may include the precise moment at which the event or situation occurs, as well as the event or situation occurring to a close approximation. For example, when combined with a numerical value, the terms may include a range of variation equal to or less than ±5% of the numerical value, such as equal to or less than ±4%, equal to or less than ±3%, equal to or less than ±2%, equal to or less than ±1%, equal to or less than ±0.5%, equal to or less than ±0.1%, or equal to or less than ±0.05%.

The technical contents of the present disclosure will become apparent with the detailed description of embodiments and the accompanied drawings as follows. However, it shall be noted that the accompanied drawings are for illustrative purposes only such that they shall not be used to restrict the scope of the present disclosure.

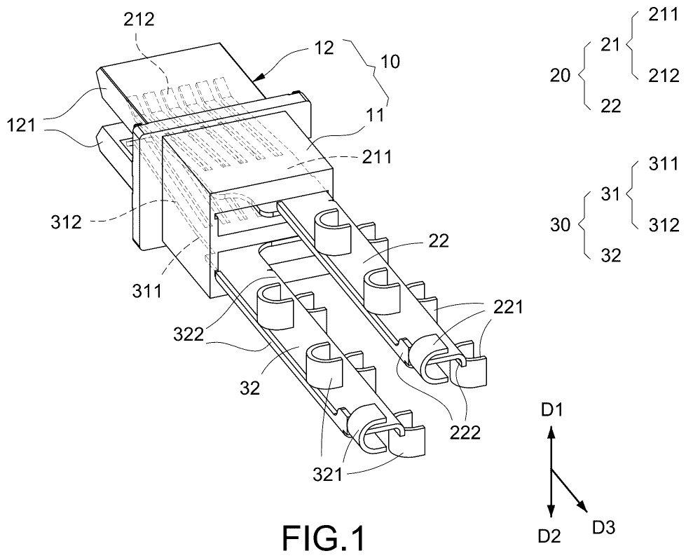

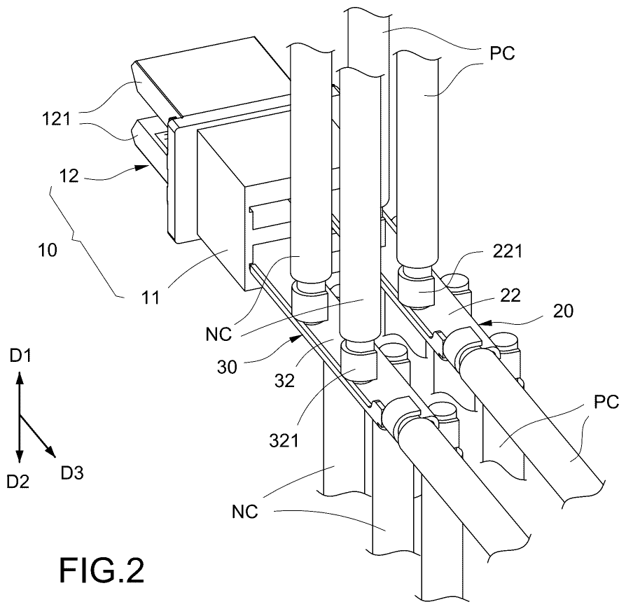

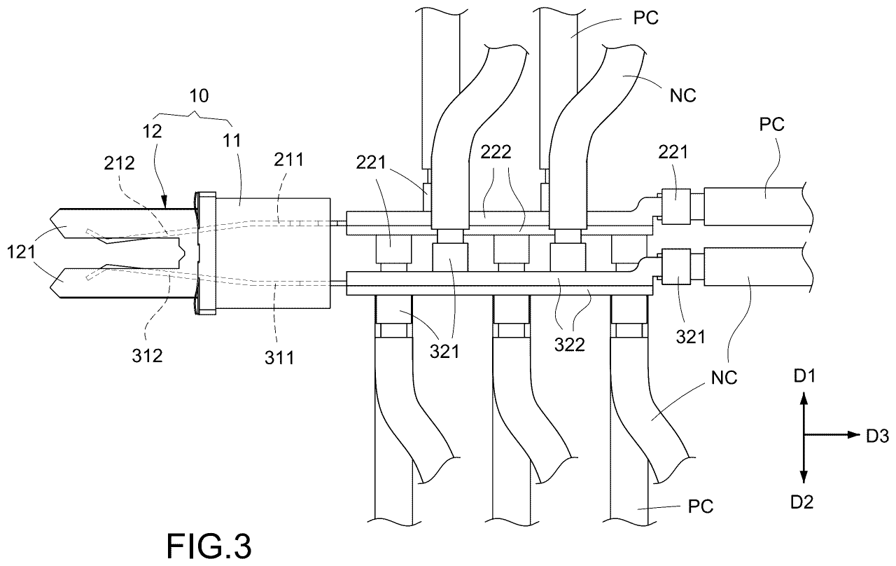

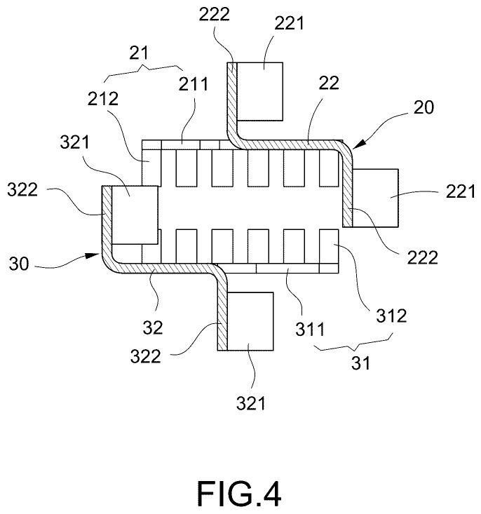

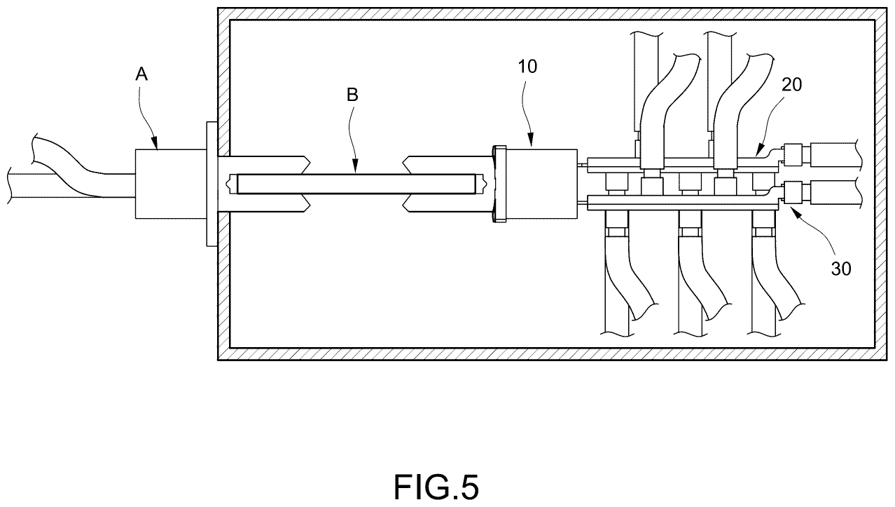

The present disclosure provides a large current cable connector for connecting a plurality of positive cables PC and a plurality of negative cables NC. As shown in FIG. 5, the large current cable connector of the present disclosure is used to assemble in a power busbar in a data enter to provide high current power output for a current connector A plugged in by connecting the positive cables PC in series with the negative cables NC in series, but the present disclosure is not limited to this embodiment. Please refer to FIG. 1, FIG. 2, FIG. 3, and FIG. 4, which show the first embodiment of the large current cable connector of the present disclosure. The large current cable connector in the first embodiment includes an insulating body 10, a positive conductor 20, and a negative conductor 30.

The insulating body 10 is made of insulating material such as plastic, the present disclosure does not specifically limit the specific material as long as the insulating body 10 is an insulating material. The insulating body 10 includes a main body 11 and a plugging portion 12 connected to each other. The insulating body 10 defines a first direction D1, a second direction D2, and a third direction D3. The first direction D1 and the second direction D2 are respectively substantially perpendicular to the third direction D3. The plugging portion 12 extends from the main body 11 away from the third direction D3. In the first embodiment, the first direction D1 and the second direction D2 are opposite directions and parallel to each other, but the present disclosure is not limited to this embodiment. As long as the first direction D1 and the second direction D2 are different directions and substantially perpendicular to the third direction D3. In detail, please take the figures as example. In the first embodiment, the first direction D1 is directed upward, the second direction D2 is directed downward, and the third direction D3 is directed backward, but the present disclosure is not limited to this embodiment.

In the first embodiment, the positive conductor 20 is made of metal with good electrical conductivity, but the present disclosure is not limited to this embodiment, the positive conductor 20 may be made of other material with good electrical conductivity. The positive conductor 20 includes a first buried section 21 and a first exposed section 22 connecting to each other. The first buried section 21 is arranged in the insulating body 10. In the first embodiment, the first buried section 21 is inserted and fixed in the insulating body 10, but the first buried section 21 may also be covered and fixed in the insulating body 10 by embedded injection. The first exposed section 22 extends along the third direction D3 to expose outside the insulating body 10. The positive conductor 20 has a plurality of positive wiring-seats 221 for connecting the positive cables PC. Part of the positive wiring-seats 221 are located on a side of the positive conductor 20 such that the corresponding positive cables PC extend along the first direction D1. Another part of the positive wiring-seats 221 are located on another side of the positive conductor 20 such that the corresponding positive cables PC extend along the second direction D2.

In the first embodiment, the negative conductor 30 is made of metal with good electrical conductivity, but the present disclosure is not limited to this embodiment, the negative conductor 30 may be made of other material with good electrical conductivity. The negative conductor 30 includes a second buried section 31 and a second exposed section 32 connecting to each other. The second buried section 31 is arranged in the insulating body 10. In the first embodiment, the second buried section 31 is inserted and fixed in the insulating body 10, but the second buried section 31 may also be covered and fixed in the insulating body 10 by embedded injection. The second exposed section 32 extends along the third direction D3 to expose outside the insulating body 10. The negative conductor 30 has a plurality of negative wiring-seats 321 for connecting the negative cables NC. Part of the negative wiring-seats 321 are located on a side of the negative conductor 30 such that the corresponding negative cables NC extend along the first direction D1. Another part of the negative wiring-seats 321 are located on another side of the negative conductor 30 such that the corresponding negative cables NC extend along the second direction D2.

Therefore, the large current cable connector of the present disclosure utilizes the features that the positive wiring-seats 221 are respectively arranged on two different sides of the first exposed section 22, and the negative wiring-seats 321 are respectively arranged on two different sides of the second exposed section 32, the large current cable connector of the present disclosure can be manufactured easily and render, quick assembling of the positive cables PC on the positive wiring-seats 221 and quick assembling of the negative cables NC on the negative wiring-seats 321 by user, and may reduce the occupied space of the positive cables PC and the negative cables NC to improve the heat dissipation efficiency of the connections of the positive cables PC and the negative cables NC.

Details are provided as follows. The second exposed section 32 is staggered and arranged parallel to the first exposed section 22. In detail, the first exposed section 22 and the second exposed section 32 may form a dislocation (yielding space) through being staggered and arranged parallel to each other such that an upper side, a lower side, a right side, and a left side of the first exposed section 22 and an upper side, a lower side, a right side, and a left side of the second exposed section 32 may form a dislocation (yielding space) to prevent interference. A number of the positive wiring-seats 221 is equal to a number of the negative wiring-seats 321, that is a number of the positive cables PC is equal to a number of the negative cables NC to ensure the overall current load and loop. The positive wiring-seats 221 are sequentially staggered on two different sides of the positive conductor 20. The negative wiring-seats 321 are sequentially staggered on two different sides of the negative conductor 30. Therefore, the positive cables PC and the negative cables NC may extend toward the first direction D1 or the second direction D2. Each of the positive wiring-seats 221 and each of the negative wiring-seats 321 are arc, semicircle, C-shaped, V-shaped or C-shaped. In the first embodiment, each of the positive wiring-seats 221 and each of the negative wiring-seats 321 are C-shaped for conveniently connecting the positive cables PC and the negative cables NC. In detail, taking the positive wiring-seats 221 and the positive cables PC as example, the user only needs to put an overlap end of the positive cable PC in the corresponding positive wiring-seat 221, then use a pliers to clamp the positive wiring-seat 221 to deform the positive wiring-seat 221 to clamp the overlap end of the positive cable PC. The way to fix the negative wiring-seats 321 and the negative cables NC is same as the way of the positive wiring-seats 221 and the positive cables PC, thus the clamping way of the negative wiring-seats 321 and the negative cables NC is not described again.

In the first embodiment, the first exposed section 22 has a pair of first bending portions 222, and the second exposed section 32 has a pair of second bending portions 322, but the present disclosure is not limited to this embodiment. The first bending portions 222 respectively extend from the first exposed section 22 toward the first direction D1 and the second direction D2, that is the first bending portions 222 in the first embodiment respectively extend from the first exposed section 22 upward and downward such that a cross-section of the first exposed section 22 is lightning-shaped, as shown in FIG. 4. Part of the positive wiring-seats 221 are located on the first bending portions 222 extended toward the first direction D1 (upward) such that the corresponding positive cables PC extend along the first direction D1. Another part of the positive wiring-seats 221 located on the first bending portions 22 extended toward the second direction D2 (downward) such that the corresponding positive cables PC extend along the second direction D2. The second bending portions 322 respectively extend from the second exposed section 32 toward the first direction D1 and the second direction D2, that is the second bending portions 322 in the first embodiment respectively extend from the second exposed section 32 upward and downward such that a cross-section of the second exposed section 32 is lightning-shaped, as shown in FIG. 4. Part of the negative wiring-seats 321 are located on the second bending portions 322 extended toward the first direction D1 (upward) such that the corresponding positive cables NC extend along the first direction D1. Another part of the negative wiring-seats 321 located on the second bending portions 322 extended toward the second direction D2 (downward) such that the corresponding positive cables NC extend along the second direction D2.

Therefore, the positive conductor 20 and the negative conductor 30 in the present disclosure may respectively be a member in one piece from a metal sheet processed by stamping/cutting and bending . . . etc., so as to ensure the conductivity or resistance value of the overall member will not have excessive deviations and to eliminate the need for additional assembly, welding or riveting. Thus, the manufacturing process is simple and fast. However, the present disclosure is not limited to this embodiment. For example, when the first direction D1 or the second direction D2 is parallel to the metal sheet of the first exposed section 22 or the second exposed section 32, the metal sheet may be bent to form the positive wiring-seats 221 or the negative wiring-seats 321 instead of additionally forming the first bending portions 222 or the second bending portions 322.

Please refer to FIG. 1, FIG. 2, and FIG. 3 again. In the first embodiment, one of the positive wiring-seats 221 is located on an end of the first exposed section 22 such that the corresponding positive cables PC extend along the third direction D3, and one of the negative wiring-seats 321 is located on an end of the second exposed section 32 such that the corresponding negative cables NC extend along the third direction D3. Therefore, not only do the positive cables PC and the negative cables NC in the first embodiment extend toward the first direction D1 and the second direction D2, but one positive cable PC and one negative cable NC also do extend toward the third direction D3. Thus, the positive cables PC and the negative cables NC from a T-shaped divergent structure to meet various wiring requirements.

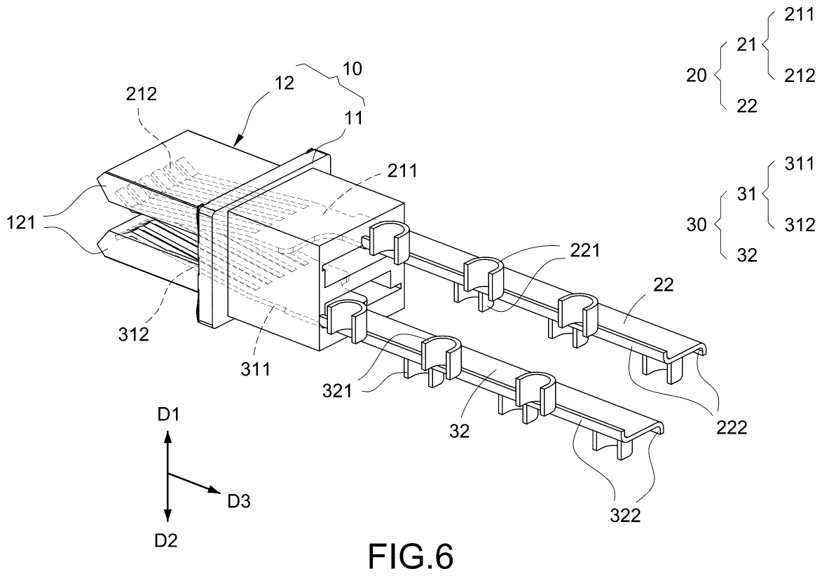

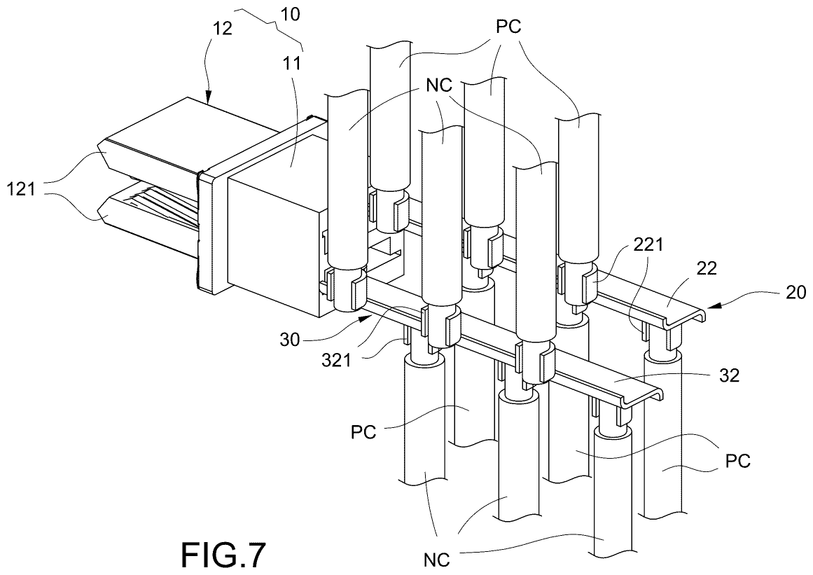

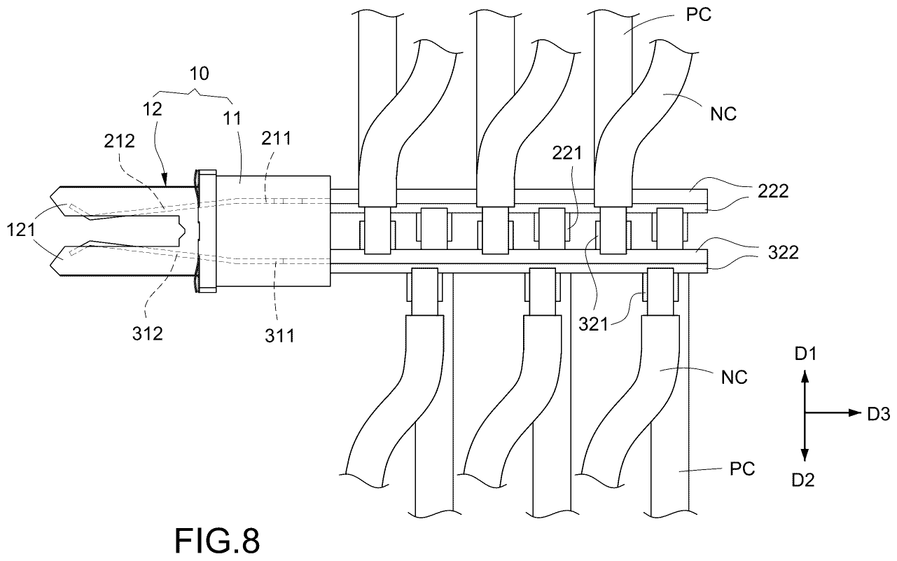

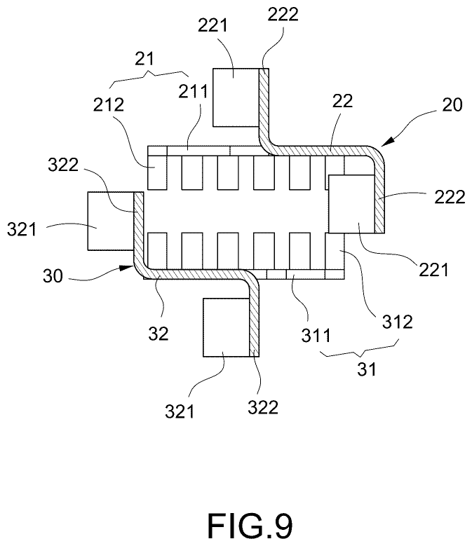

Please refer to FIG. 6, FIG. 7, FIG. 8, and FIG. 9, which show the second embodiment of the large current cable connector of the present disclosure. The mainly difference between the second embodiment and the first embodiment is that the end of the first exposed section 22 and the end of the second exposed section 32 are not arranged with the positive wiring-seat 221 and the negative wiring-seat 321. In detail, the positive wiring-seats 221 in the second embodiment are arranged staggered in sequence on the first bending portions 222, and the negative wiring-seats 321 in the second embodiment are arranged staggered in sequence on the second bending portions 322. Therefore, the positive cables PC and the negative cables NC extend toward the first direction D1 or the second direction D2 to be suitable for use when the configuration space of the third direction D3 is limited.

Details are provided as follows. The plugging portion 12 of the insulating body 10 in the second embodiment has a pair of plug-clamping plates 121 opposite to each other. The first buried section 21 includes a first connecting portion 211 and a plurality of positive terminals 212. The first connecting portion 211 is connected between the first exposed section 22 and the positive terminals 212, and each of the positive terminals 212 is corresponding to one of the plug-clamping plates 121. The second buried section 31 includes a second connecting portion 311 and a plurality of negative terminals 312. The second connecting portion 311 is connected between the second exposed section 32 and the negative terminals 312, and the negative terminals 312 are corresponding to the other plug-clamping plate 121. In detail, the positive terminals 212 extend from the first connecting portion 211 toward the negative terminals 312, and the negative terminals 312 extend from the second connecting portion 311 toward the positive terminals 212. Therefore, please refer to FIG. 5 again. When the plugging portion 12 of the insulating body 10 is plugged in a circuit board B, each of the plug-clamping plates 121 is clamped and fixed to two opposite sides of the circuit board B, and the positive terminals 212 and the negative terminals 312 are respectively elastically clamped the two opposite sides of the circuit board B to form an electrical connection.

In the large current cable connector of the present disclosure, the positive wiring-seats 221 are arranged on the first exposed section 22 of the positive conductor 20, the negative wiring-seats 321 are arranged on the second exposed section 32 of the negative conductor 30, the positive wiring-seats 221 are respectively arranged on two different sides of the first exposed section 22, and the negative wiring-seats 321 are respectively arranged on two different sides of the second exposed section 32. Therefore, the large current cable connector of the present disclosure may be easily manufactured, render quick assembling of the positive cables PC on the positive wiring-seats 221 and quick assembling of the negative cables NC on the negative wiring-seats 321 by user, and may reduce the occupied space of the positive cables PC and the negative cables NC to improve the heat dissipation efficiency of the connections of the positive cables PC and the negative cables NC.

It shall be understood that the present disclosure may have other types of embodiments, and a person with ordinary skills in the art of the technical field of the present disclosure may make various changes and modifications corresponding to the present disclosure without deviating the principle and substance of the present disclosure; however, such corresponding changes and modification shall be considered to be within the claimed scope of the present disclosure.

What is claimed is:

1. A large current cable connector for connecting a plurality of positive cables and a plurality of negative cables comprising:
an insulating body;
a positive conductor, comprising a first buried section and a first exposed section connecting to each other, the first buried section arranged in the insulating body, the first exposed section extending along a third direction to expose outside the insulating body, the positive conductor comprising a plurality of positive wiring-seats for connecting the positive cables, part of the positive wiring-seats located on a side of the positive conductor such that the corresponding positive cables extend along a first direction, another part of the positive wiring-seats located on another side of the positive conductor such that the corresponding positive cables extend along a second direction, wherein the first direction and the second direction is respectively perpendicular to the third direction;
a negative conductor, comprising a second buried section and a second exposed section connecting to each other, the second buried section arranged in the insulating body, the second exposed section extending along the third direction to expose outside the insulating body, the negative conductor comprising a plurality of negative wiring-seats for connecting the negative cables, part of the negative wiring-seats located on a side of the negative conductor such that the corresponding negative cables extend along the first direction, another part of the negative wiring-seats located on another side of the negative conductor such that the corresponding negative cables extend along the second direction.

2. The large current cable connector according to claim 1, wherein a number of the positive wiring-seats is equal to a number of the negative wiring-seats.

3. The large current cable connector according to claim 1, wherein one of the positive wiring-seats is located on an end of the first exposed section such that the corresponding positive cables extend along the third direction, one of the negative wiring-seats is located on an end of the second exposed section such that the corresponding negative cables extend along the third direction.

4. The large current cable connector according to claim 1, wherein the second exposed section is staggered and arranged parallel to the first exposed section.

5. The large current cable connector according to claim 1, wherein the first direction and the second direction are opposite directions and parallel to each other.

6. The large current cable connector according to claim 1, wherein the positive wiring-seats are sequentially staggered on two different sides of the positive conductor, the negative wiring-seats are sequentially staggered on two different sides of the negative conductor.

7. The large current cable connector according to claim 1, wherein each of the positive wiring-seats and each of the negative wiring-seats are arc, semicircle, C-shaped, V-shaped or C-shaped.

8. The large current cable connector according to claim 1, wherein the first exposed section comprises a pair of first bending portions, the first bending portions respectively extend from the first exposed section toward the first direction and the second direction, part of the positive wiring-seats are located on the first bending portions extended toward the first direction such that the corresponding positive cables extend along the first direction, another part of the positive wiring-seats located on the first bending portions extended toward the second direction such that the corresponding positive cables extend along the second direction.

9. The large current cable connector according to claim 1, wherein the second exposed section comprises a pair of second bending portions, the second bending portions respectively extend from the second exposed section toward the first direction and the second direction, part of the negative wiring-seats are located on the second bending portions extended toward the first direction such that the corresponding positive cables extend along the first direction, another part of the negative wiring-seats located on the second bending portions extended toward the second direction such that the corresponding positive cables extend along the second direction.

10. The large current cable connector according to claim 1, wherein the insulating body comprises a pair of plug-clamping plates opposite to each other, the first buried section comprises a first connecting portion and a plurality of positive terminals, the first connecting portion is connected between the first exposed section and the positive terminals, each of the positive terminals is corresponding to one of the plug-clamping plates, the second buried section comprises a second connecting portion and a plurality of negative terminals, the second connecting portion is connected between the second exposed section and the negative terminals, the negative terminals are configured to the other plug-clamping plate.
